(19) United States
(12) Patent Application Publication
(10) Pub. No.: US 2026/0085980 A1
(43) Pub. Date: Mar. 26, 2026

(54) TEMPERATURE MEASUREMENT METHOD AND DEVICE FOR SUBMARINE CABLE FACTORY JOINTS

(71) Applicant: ELECTRIC POWER RESEARCH INSTITUTE. CHINA SOUTHERN POWER GRID, Guangzhou (CN)

(72) Inventors: Shuai HOU, Guangzhou (CN); Mingli FU, Guangzhou (CN); Lei JIA, Guangzhou (CN); Yunpeng ZHAN, Guangzhou (CN); Baojun HUI, Guangzhou (CN); Wenbo ZHU, Guangzhou (CN); Bin FENG, Guangzhou (CN); Jie LIU, Guangzhou (CN)

(73) Assignee: ELECTRIC POWER RESEARCH INSTITUTE. CHINA SOUTHERN POWER GRID, Guangzhou (CN)

(21) Appl. No.: 19/105,127

(22) PCT Filed: Oct. 26, 2022
(86) PCT No.: PCT/CN2022/127537

§ 371 Date: Dec. 1, 2025

(30) Foreign Application Priority Data
Sep. 28, 2022 (CN) 202211196327.1

(51) Int. Cl. G01K 7/16

(52) U.S. Cl. CPC G01K 7/16

(57) ABSTRACT

A temperature measurement method for submarine cable factory joints and a device therefor are provided. The method includes: obtaining (S201) measured temperature values of respective reference key areas of a reference submarine cable factory joint, a main body structure of the reference submarine cable factory joint being the same as that of a target submarine cable factory joint, environment where the reference submarine cable factory joint is located is the same as environment where the target submarine cable factory joint is located, and the reference submarine cable factory joint and the target submarine cable factory joint are spaced apart from each other by a preset distance and then placed side by side; and determining (S202) the measured temperature values of respective reference key areas as measured temperature values of corresponding measurement key areas of the target submarine cable factory joint.

### CROSS-REFERENCE TO RELATED APPLICATIONS

This application is a U.S. National Stage Application, filed under 35 U.S.C. 371, of International Patent Application No. PCT/CN2022/127537, filed on Oct. 26, 2022, which claims priority to Chinese Patent Application No. 202211196327.1, entitled “TEMPERATURE MEASUREMENT METHOD FOR SUBMARINE CABLE FACTORY JOINTS AND TEMPERATURE MEASUREMENT DEVICE THEREFOR” and filed with the CNIPA on Sep. 28, 2022, the entire contents of which are incorporated herein by reference.

### TECHNICAL FIELD

The present disclosure relates to the technical field of cable accessory, and in particular, to a temperature measurement method for submarine cable factory joints and a temperature measurement device therefor.

### BACKGROUND

Submarine cable factory joints have higher operational stability than prefabricated joints because the same material as that for insulation of the cable body is utilized for insulation restoration of the submarine cable factory joints and the submarine cable factory joints are similar to the cable body in structure and size.

Generally, in manufacturing process of the submarine cable factory joints, preheating of parts, e.g., anti-stress cone insulation and conductor shielding restoration as well as precise temperature control over operations such as heat-induced extrusion and heat-induced crosslink for insulation restoration are important prerequisites to ensure high quality of insulation of the submarine cable factory joints. In the related art, operation steps (including a heating approach and heating source power control) of preheating before extruded insulation are mainly determined by a fixed scheme explored by technicians in the early stage or according to field experience. However, when emergencies such as power outage, indoor temperature changes, or unstable heating source power occur during the heating, temperatures of key parts of the submarine cable factory joints can no longer be predicted based on experience, and changes occurring in the temperatures of the submarine cable factory joints are unknown, which is very likely to have negative impacts on subsequent manufacturing of the submarine cable factory joints and overall quality of insulation thereof.

Therefore, there is a lack of an effective real-time measurement means for the temperatures in key areas of the submarine cable factory joints in respective heating process links during the manufacturing of the submarine cable factory joints, which has negative impacts on real-time adjustment and control over a processing technology of the submarine cable factory joints and operational reliability of the submarine cable factory joints.

### SUMMARY

In view of the above, a temperature measurement method for submarine cable factory joints and a temperature measurement device therefor are provided according to various embodiments of the present disclosure, which can monitor temperatures of key areas of the submarine cable factory joints in real time in respective heating process links during the manufacturing of the submarine cable factory joints, thereby facilitating real-time adjustment and control over the processing technology of the submarine cable factory joints and improving operational reliability of the submarine cable factory joints.

The present disclosure provides a temperature measurement method for submarine cable factory joints. The method includes:
obtaining measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side; and
determining the measured temperature values of respective reference key areas as measured temperature values of corresponding measurement key areas of the target submarine cable factory joint.

In a second aspect, the present disclosure further provides a temperature measurement device for submarine cable factory joints. The device includes:
an obtaining module, configured to obtain measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side; and
a temperature determination module, configured to determine the measured temperature values of the respective reference key areas as measured temperature values of corresponding measurement key areas of the target submarine cable factory joint.

In a third aspect, the present disclosure further provides a computer apparatus. The computer apparatus includes a memory and a processor. The memory stores a computer program. The processor, when executing the computer program, implements steps of the method provided in any embodiment in the first aspect.

In a fourth aspect, the present disclosure further provides a computer-readable storage medium, having a computer program stored thereon. When the computer program is executed by a processor, steps of the method provided in any embodiment in the first aspect are implemented.

In a fifth aspect, the present disclosure further provides a computer program product, including a computer program. When the computer program is executed by a processor, steps of the method provided in any embodiment in the first aspect above are implemented.

Details of one or more embodiments of the present disclosure are set forth in the following accompanying drawings and descriptions. Other features, objectives, and advantages of the present disclosure become obvious with reference to the specification, the accompanying drawings, and the claims.

### BRIEF DESCRIPTION OF THE DRAWINGS

In order to better describe and illustrate embodiments and/or examples of the present disclosure, reference may be made to one or more accompanying drawings. Additional details or examples used to describe the accompanying drawings should not be considered as limitations on the scope of any of the present disclosure, the presently described embodiments and/or examples, and the presently understood best mode of the present disclosure.

FIG. 1 is a diagram of an application environment of a temperature measurement method for submarine cable factory joints according to some embodiments;

FIG. 2 is a schematic flowchart of a temperature measurement method for submarine cable factory joints according to some embodiments;

FIG. 3 is a schematic structural diagram of submarine cable factory joints according to some embodiments;

FIG. 4 is a schematic structural diagram of submarine cable factory joints according to some other embodiments;

FIG. 5 is a cloud diagram of temperature distribution of a submarine cable factory joint according to some embodiments;

FIG. 6 is a schematic diagram of changes in temperatures of key areas in a submarine cable factory joint over time according to some embodiments;

FIG. 7 is a schematic diagram of changes in temperatures at a center of a core of a submarine cable factory joint along a length direction of a cable core according to some embodiments;

FIG. 8 is a process architecture diagram of a temperature measurement method for submarine cable factory joints according to some embodiments;

FIG. 9 is a structural block diagram of a temperature measurement device for submarine cable factory joints according to some embodiments; and

FIG. 10 is a diagram of an internal structure of a computer apparatus according to some embodiments.

### REFERENCE SIGNS

metal cooling jacket 11; metal heating mould 12; anti-stress cone 13; electromagnetic coil 14; conductor core 15; insulating material extrusion flow channel port 16; silicone rubber gasket 17.

### DETAILED DESCRIPTION

To further clarify the objectives, technical solutions, and advantages of the present disclosure, the present disclosure is further detailed below with reference to the accompanying drawings and embodiments. It should be understood that specific embodiments described herein are intended merely to explain the present disclosure rather than to limit the present disclosure.

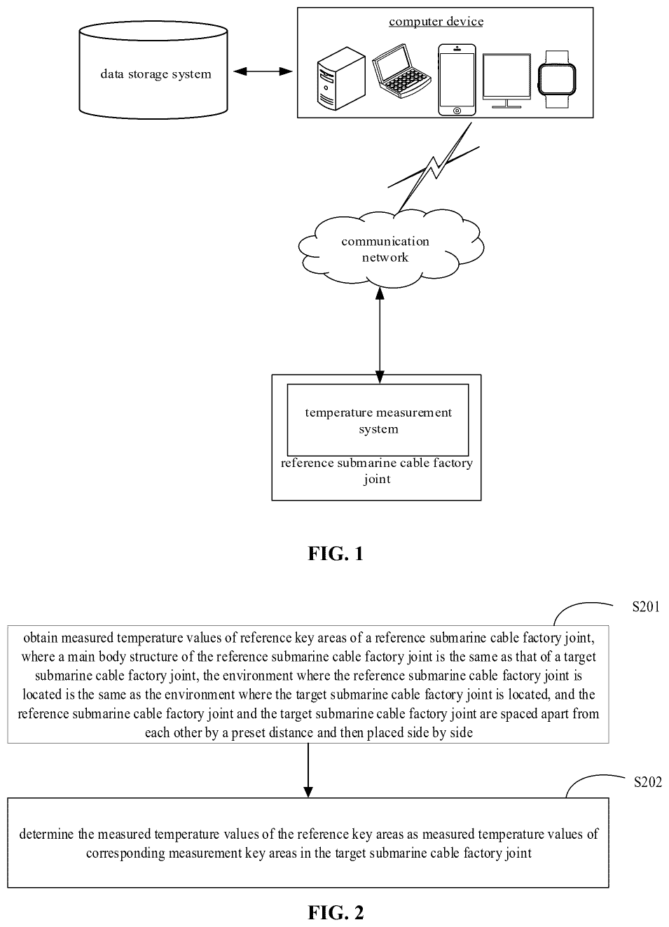

A temperature measurement method for submarine cable factory joints provided in embodiments of the present disclosure may be applied to an application environment as shown in FIG. 1. A temperature measurement system communicates with a computer device over a network. The temperature measurement system is mounted in a reference submarine cable factory joint, and is configured to collect measured temperature values of an area where the temperature measurement system is located and transmit the collected measured temperature values to the computer device. A data storage system may store data to be processed by the computer device. The data storage system may be integrated on the computer device or placed on a cloud or other network servers. The computer device may be, but is not limited to, various personal computers, laptops, smart phones, tablet computers, and the like.

A high-voltage crosslinked polyethylene insulated power cable is an important infrastructure for power transmission, especially for power transmission across a large area of sea. Since overhead lines cannot be laid, the use of the high-voltage crosslinked polyethylene insulated submarine cable has become an inevitable choice. For the high-voltage crosslinked polyethylene submarine cable, a continuous length is one of the basic requirements. Since there is a limit to a manufacturing length of a single cable and laying of submarine cables avoids the use of prefabricated cable intermediate joints as much as possible, in order to achieve a sufficient transmission distance, submarine cable factory joints must be used to connect multiple cable sections to a required length. Such submarine cable factory joints are also called factory flexible joints.

However, after researching the submarine cable factory joints in related technology, the applicant finds that manufacturing of the submarine cable factory joints is extremely difficult and it is difficult to achieve reliable long-term operating performance under a limited insulation thickness in case that integrity and consistency of insulation of a cable body are destroyed. Even experienced cable manufacturers cannot fully guarantee successful manufacturing of the submarine cable factory joints, and manufacturing yield is very low. Generally, products barely passing a type test may be generated after several times or even a dozen times of manufacturing of high-voltage submarine cable factory joints.

Further, the applicant also finds that in the related technology, before extruded insulation, it is necessary to connect cores of two cable sections and connect inner shielding layers of the two cable sections. An insulation layer near a connection between the two cable sections may be sharpened into an anti-stress cone in a shape of a “pencil head”, and then a process of “crosslinkable polyethylene material extrusion and high-temperature and high-pressure insulation crosslink” may be carried out. This process is recognized as the most difficult and critical link for the submarine cable factory joints. During this process after a mould and a heating device are mounted, a conductor core is generally preheated first, and then insulation is extruded into a mould chamber through an injection molding port when an external mould is heated at the same time. The temperature in the extrusion procedure should be strictly controlled. If the temperature is excessively high, the material may be cross-linked prematurely and the quality of insulation may be affected. If the temperature is excessively low, the material may lose fluidity. Then, after the extrusion procedure is completed, a heating temperature of the mould may be increased, and under sufficient pressure, the material may be crosslinked in the mould. Similarly, the temperature in the crosslink procedure should also be strictly controlled. An excessively high temperature may lead to material aging, and an excessively low temperature may lead to insufficient crosslink of the material. It should be emphasized that during the manufacturing of the submarine cable factory joints, since a structure includes cables, the mould, and joint insulation at the same time and the insulation is flow-injected, temperature distribution at different positions in the above structure may be very complicated. In order to ensure integrity and high cleanliness of a cable insulation structure, during the manufacturing of the submarine cable factory joint, temperature measuring elements are not allowed to be placed in key parts thereof. In a technology, various operation steps (including a heating approach and heating source power control) of the above procedures are mainly determined by a fixed scheme explored by technicians in the early stage or according to field experience. However, as the structure and the size of the cables change, the temperatures of the key parts of the submarine cable factory joint may no longer conform to the previous experience, and there may be large temperature control deviation. An excessively high temperature may lead to overheating aging or deformation during the processing of insulation material, and an excessively low temperature may cause serious structural defects (such as bubbles, low density of the insulation material) in the submarine cable factory joint for the cables. Even if the structure and the size of the cables are fixed, if emergencies such as power outage, indoor temperature changes, or unstable heating source power occur during the heating in the processing of the submarine cable factory joint, the temperatures of the key parts of the submarine cable factory joint can no longer be predicted based on experience, and changes occurring in the temperatures of the submarine cable factory joint are unknown, which is very likely to have negative impacts on subsequent manufacturing of the submarine cable factory joints and overall quality of insulation thereof.

In the related technology, there is a lack of an effective real-time measurement means for the temperatures in key areas of respective heating process links during the manufacturing of the submarine cable factory joint, which has negative impacts on real-time adjustment and control over a processing technology of the submarine cable factory joints and operational reliability of the submarine cable factory joints.

In view of the above, after research, the applicant proposes a measuring method for submarine cable factory joints, which may determine measured temperature values of reference key areas as measured temperature values of corresponding measurement key areas in a target submarine cable factory joint. A reference submarine cable factory joint and the target submarine cable factory joint are spaced apart from each other by a preset distance and then placed side by side, which prevents electromagnetic signal interference between the two and ensures that the two are in the same electromagnetic environment and the same ambient temperature environment.

Moreover, the main body structure of the reference submarine cable factory joint is designed to be the same as that of the target submarine cable factory joint. The structure of the reference joint merely differs in the addition of relatively small temperature sensors and leads thereof, which can be implemented by setting a few narrow lead outlets in the closed mould. Due to small sizes and light weights, the leads and the narrow lead outlets have negligible impacts on an electromagnetic environment and thermal field distribution of the joint. Therefore, the reference submarine cable factory joint and the target submarine cable factory joint can be considered to have same main body structures. Besides, since the reference submarine cable factory joint and the target submarine cable factory joint are heated by the same heating source device, and electromagnetic heating coils or resistance heating wires configured to heat the two joints are wound in exactly the same way and connected in parallel or in series to the same power supply, synchronous heating of the two joints can be achieved, which prevents problems such as temperature desynchronization and mismatch caused by fluctuations in heating source parameters.

It is to be noted that the measuring method for submarine cable factory joints provided in embodiments of the present disclosure is not limited to the above technical advantages, and other technical advantages may also be achieved with reference to the following description, which are not described in detail herein.

A temperature measurement method for submarine cable factory joints provided in embodiments of the present disclosure is described below.

In an embodiment, as shown in FIG. 2, a temperature measurement method for submarine cable factory joints is provided. The embodiment involves a process of obtaining measured temperature values of reference key areas of a reference submarine cable factory joint and determining the measured temperature values of the reference key areas as measured temperature values of corresponding measurement key areas in a target submarine cable factory joint. The embodiment includes the following steps S201 and S202.

In S201, measured temperature values of respective reference key areas of a reference submarine cable factory joint are obtained, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side.

The submarine cable factory joint in the embodiments of the present disclosure is also referred to as a flexible joint, which may be, for example, a submarine cable factory joint for high-voltage crosslinked polyethylene power cables.

The target submarine cable factory joint refers to a submarine cable factory joint in which temperatures of key areas are currently required to be measured, and may be understood as a joint that is being formally manufactured in actual applications. Optionally, the target submarine cable factory joint may be a submarine cable factory joint to be heated during the manufacturing of the submarine cable factory joint, that is, a submarine cable factory joint currently to be heated. The target submarine cable factory joint may refer to a submarine cable factory joint that has completed steps such as shaping and grinding of the anti-stress cone, welding (or pressure welding) of the conductor core, conductor shielding wrapping, and the like and is about to undergo steps such as preheating of the anti-stress cone and extrusion for insulation restoration, and may alternatively refer to a submarine cable factory joint that has completed steps such as molding of extrusion for insulation restoration and is about to undergo a step of heat-induced crosslink for insulation restoration. The link referred to by the target submarine cable factory joint is not limited in the embodiments of the present disclosure, which is applicable to any submarine cable factory joint for plastic insulated power cables.

The key areas in the submarine cable factory joint include, but are not limited to, parts such as anti-stress cone insulation, conductor shielding restoration, and a conductor core at a high-frequency induction coil. The anti-stress cone and the conductor shielding restoration are located in a middle position of a cable of the submarine cable factory joint.

In practical applications, considering limitations of integrity and insulation purity of an insulation structure of the submarine cable factory joint, temperature measuring elements cannot be placed at parts such as the anti-stress cone insulation, the conductor shielding restoration, and the conductor core at the high-frequency induction coil. Based on this, in the embodiments of the present disclosure, the temperatures of the key areas in the target submarine cable factory joint are monitored by setting the reference submarine cable factory joint instead of based on the target submarine cable factory joint. Naturally, the reference submarine cable factory joint is a joint on which temperature measurement is performed rather than on the target submarine cable factory joint, to ensure integrity and purity of the target submarine cable factory joint.

Further, it may be understood that in the embodiments of the present disclosure, main body structures of the reference submarine cable factory joint and the target submarine cable factory joint are required to be exactly the same, and the environments where the reference submarine cable factory joint and the target submarine cable factory joint are located are also required to be exactly the same, to ensure that the temperatures of the areas in the reference submarine cable factory joint may be more accurately equivalent to the temperatures of the corresponding areas in the target submarine cable factory joint.

Moreover, in the embodiments of the present disclosure, the reference submarine cable factory joint and the target submarine cable factory joint are heated by the same heating source device, and electromagnetic heating coils or resistance heating wires used to heat the two joints are wound in exactly the same way and connected to the same power supply in parallel or in series, to achieve synchronous heating of the two joints.

Reference is made to FIG. 3. In FIG. 3, A denotes a target submarine cable factory joint A, and B denotes a reference submarine cable factory joint. As can be seen from FIG. 3, the main body structure of the reference submarine cable factory joint is completely the same as that of the target submarine cable factory joint.

In order to ensure that the environments where the reference submarine cable factory joint and the target submarine cable factory joint are located are the same, the two are required to be placed in one environment. For example, as schematically shown in FIG. 3, the reference submarine cable factory joint and the target submarine cable factory joint are placed side by side to ensure that they are in the same environment. In addition, it can also be seen from FIG. 3 that both the reference submarine cable factory joint and the target submarine cable factory joint are provided with electromagnetic coils at two ends, which may naturally generate magnetic fields. In order to ensure that the reference submarine cable factory joint and the target submarine cable factory joint are not affected by the magnetic fields generated by electromagnetic coils of each other when they are placed side by side, they are required to be spaced apart by a certain distance. For example, the two joints are spaced apart from each other by a distance of 0.5 meters to 1 meter and then placed side by side. It is to be noted that in the embodiments of the present disclosure, lengths of the reference submarine cable factory joint and the target submarine cable factory joint are not required to be exactly the same. However, the cable core conducts heat. In order to ensure that the temperatures measured in the key areas of the reference submarine cable factory joint are consistent with those of the target submarine cable factory joint and to eliminate errors of the temperatures measured in the reference submarine cable factory joint, a total length of cable parts at two ends of the reference submarine cable factory joint may be set to at least 20 meters, and lengths of cables at two ends of the reference joint are equal (both are equal to or longer than 10 meters).

Based on the above reference submarine cable factory joint, the measured temperature values of the reference key areas of the reference submarine cable factory joint may be obtained. The reference key areas herein refer to key areas in the reference submarine cable factory joint, which are in one-to-one correspondence to positions of the key areas in the target submarine cable factory joint.

Exemplarily, obtaining the measured temperature values of the reference key areas of the reference submarine cable factory joint may involve mounting temperature measurement devices in the reference key areas of the reference submarine cable factory joint and then reading temperatures measured by the temperature measurement devices to obtain the measured temperature values of the reference key areas of the reference submarine cable factory joint.

In S202, the measured temperature values of the respective reference key areas are determined as measured temperature values of corresponding measurement key areas of the target submarine cable factory joint.

Based on the measured temperature values of the reference key areas of the reference submarine cable factory joint obtained above, the temperature values measured are directly determined as the measured temperature values of the corresponding key areas in the target submarine cable factory joint.

In the embodiment of the present disclosure, a computer apparatus obtains measured temperature values of reference key areas of a reference submarine cable factory joint and determines the measured temperature values of the reference key areas as measured temperature values of corresponding measurement key areas in a target submarine cable factory joint. The main body structure of the reference submarine cable factory joint is the same as that of the target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side. In this way, the key areas in the reference submarine cable factory joint may be fully equivalent to the key areas in the target submarine cable factory joint, that is, temperature distribution in the reference submarine cable factory joint is consistent with that in the target submarine cable factory joint, thereby achieving accurate monitoring of the temperatures of respective key areas in the target submarine cable factory joint during the heating through the reference submarine cable factory joint.

Next, before introduction to an implementation process of the above temperature measurement system, the environments and the main body structures of the reference submarine cable factory joint and the target submarine cable factory joint are first described in terms of structures.

Based on the above description, in the embodiments of the present disclosure, the temperatures of the key areas are measured based on precise temperature control over a heating link involved in the manufacturing process of the submarine cable factory joint, which is an important prerequisite for ensuring high-quality insulation of the target submarine cable factory joint. Therefore, in implementation of the embodiments of the present disclosure, manners of heating the reference submarine cable factory joint and the target submarine cable factory joint are required to be described first.

In an embodiment, based on the principle of electromagnetic induction heating, electromagnetic coils may be used to directly generate an eddy current in the conductor core, and a metal external heating mould is also used, which can achieve rapid heating of the reference submarine cable factory joint and the target submarine cable factory joint and can also prevent problems such as uneven insulation temperature and excessively long heating time in a one-way heating technology from the outside of the cable to the inside of the cable. Therefore, in the embodiments of the present disclosure, the reference submarine cable factory joint and the target submarine cable factory joint are heated by using a magnetic induction heating approach, and the reference submarine cable factory joint and the target submarine cable factory joint each include an electromagnetic induction heating system, a metal cooling jacket, and a metal heating mould.

In an embodiment, as shown in FIG. 4, A denotes a target submarine cable factory joint, B denotes a reference submarine cable factory joint, 14 denotes an electromagnetic coil, 15 denotes a conductor core, 16 denotes an insulating material extrusion flow channel port, 17 denotes a silicone rubber gasket, 13 denotes an anti-stress cone, 12 denotes a metal heating mould, and 11 denotes a metal cooling jacket.

Electromagnetic coils are placed symmetrically on two sides of each of the reference submarine cable factory joint and the target submarine cable factory joint to ensure that the temperatures in the entire area of each of the reference submarine cable factory joint and the target submarine cable factory joint can be uniform. The reference submarine cable factory joint and the target submarine cable factory joint are identical both in terms of their structures (except lengths) and heating devices.

The metal cooling jacket and the metal heating mould above are first described. In an embodiment, the reference submarine cable factory joint and the target submarine cable factory joint include same metal cooling jackets and same metal heating moulds. The metal heating mould is arranged on an outer side of the anti-stress cone of the target submarine cable factory joint or the reference submarine cable factory joint. The metal cooling jacket is located on two sides of the metal heating mould and in close contact with the metal heating mould and an outer side of a cable.

The metal heating mould refers to a mould mounted on an outer side of the anti-stress cone of each of the target submarine cable factory joint and the reference submarine cable factory joint. The mould may be a mould for extrusion for insulation restoration or a mould for heat-induced crosslink for insulation restoration. A structure of the mould may be adjusted according to requirements in practical applications.

The metal cooling jacket is located on two sides of the metal heating mould and is in close contact with the metal heating mould and the outer side of the cable, and is used to cool down cable insulation layers on two sides of the metal heating mould to prevent deformation of the insulation due to an excessively high temperature. The metal cooling jacket is placed abutting against two sides of the metal heating mould and cools down the cable insulation layers by air cooling or water cooling. In this way, cables of the reference submarine cable factory joint and the target submarine cable factory joint may not deform due to heating of the insulation.

In the embodiment, the metal heating mould and the metal cooling jacket are arranged in each of the target submarine cable factory joint and the reference submarine cable factory joint, so that extrusion moulds of the target submarine cable factory joint and the reference submarine cable factory joint can be restored to insulation to form desired shapes, and the cable insulation layers on outer sides of the extrusion moulds can be cooled down, preventing deformation due to heating.

The metal cooling jacket and the metal heating mould above are mounted based on the requirement of the induction heating system. The induction heating system is described below. In an embodiment, the induction heating system includes an electromagnetic coil and an induction heating power supply (not illustrated in FIG. 4), the electromagnetic coil is arranged on two sides of the metal cooling jacket, and a distance between the electromagnetic coil and the metal cooling jacket is greater than a preset distance.

The electromagnetic coil may be a fixed coil with water cooling or a hand-wound electromagnetic wire, which is located on two sides of the metal cooling jacket and has a preset distance from the metal cooling jacket. For example, the distance may be greater than or equal to 5 cm. In this way, overheating of the metal cooling jacket due to a magnetic field generated by the electromagnetic coil can be prevented.

In practical applications, when a high-frequency large current is applied to the electromagnetic coil, the magnetic field generated can pass through the insulation shielding and the insulation layer, causing the conductor core at a position corresponding to the electromagnetic coil to generate an eddy current and rapidly heat up, and then heat is transferred to the conductor core at the submarine cable factory joint to heat up the conductor shielding restoration and an inner side of the anti-stress cone. By controlling an output current and an electric power of the induction heating power supply, the cable core in the submarine cable factory joint is heated up. For example, a frequency of the output current of the induction heating power supply ranges from 1 kHz to 50 kHz. The frequency in the range can quickly heat up the conductor core at the induction coil and ensure that the insulation shielding at the electromagnetic coil may not be heated up excessively under the action of the magnetic field. In another example, the electric power of the induction heating power supply is controlled equal to or more than 10 kW, which can enable rapid heating of the conductor core.

In the embodiment, an induction heating system is mounted at the submarine cable factory joint, including an electromagnetic coil and an induction heating power supply. Through an output current and an electric power of the induction heating power supply, the conductor core at the electromagnetic coil is rapidly heated up, and then heat is transferred to the conductor core at the submarine cable factory joint. In this way, temperatures on inner sides of the key areas (e.g., the conductor shielding restoration and the inner side of the anti-stress cone) of the submarine cable factory joint can be increased, thereby achieving heating effects of respective key areas in the submarine cable factory joint.

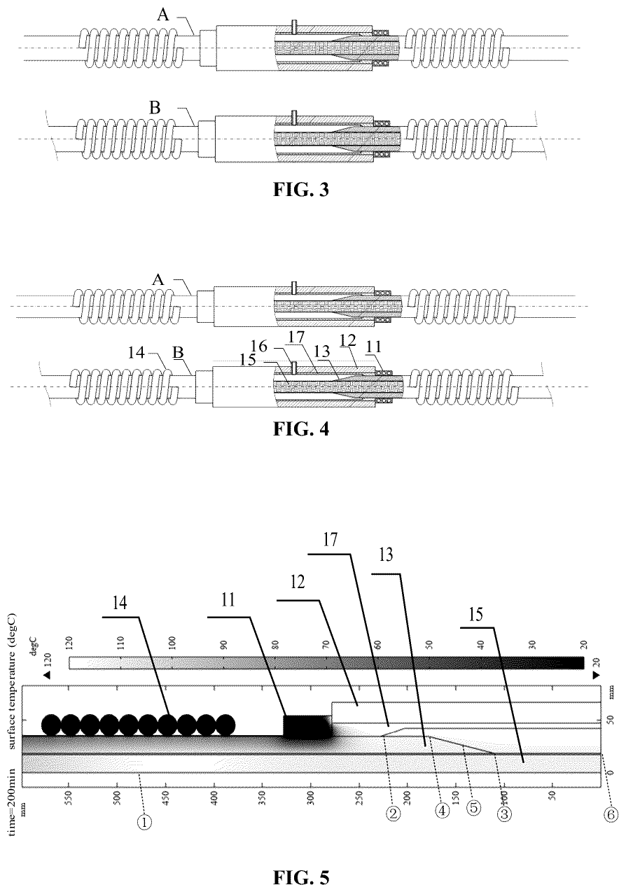

Reference is made to FIG. 5, which is a schematic cloud diagram of simulation calculation temperature distribution of the reference submarine cable factory joint at the 200th minute in preheating. Here, exemplarily, the reference submarine cable factory joint is for a crosslinked polyethylene insulated power cable which is of a voltage class of 110 kV and includes a copper conductor core having a cross-section of 800 mm². FIG. 5 is a cloud diagram of temperature distribution of the reference submarine cable factory joint, obtained by simulation calculation under a condition of heating with a current having a frequency of 15 kHz and an effective value of 180A for 70 minutes, and heating with a current having a frequency of 15 kHz and an effective value of 140A for 130 minutes.

In the embodiment of the present disclosure, the target submarine cable factory joint uses the same electromagnetic coil as the reference submarine cable factory joint, and current amplitudes and frequencies in the electromagnetic coils are consistent, ensuring that electromagnetic induction heating for the two joints achieves the same effect. Therefore, in an actual process, the electromagnetic coils may be implemented by using an electromagnetic flexible wire structure and are powered by the same magnetic induction heating power supply. Compared with the traditional approach of heating the outer side of the metal mould alone which takes tens of hours or even several days, combining magnetic induction heating in the embodiment of the present disclosure can rapidly improve heating efficiency by selecting an appropriate heating process. For example, it takes less than 4 hours to raise the temperatures of the key areas of the submarine cable factory joint to about 110° C. In this way, heating efficiency in the key areas of the submarine cable factory joint is greatly improved.

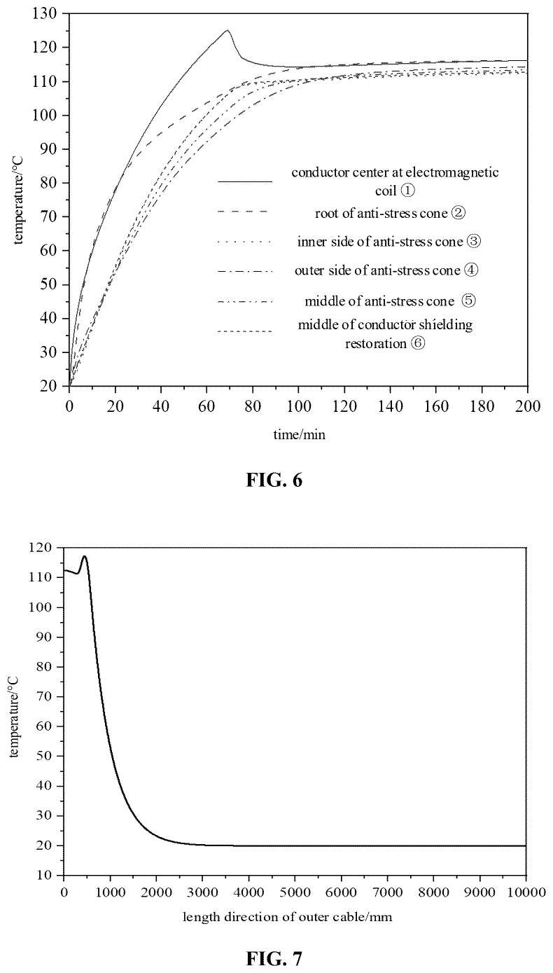

Reference is made to FIG. 6, which is a schematic diagram of changes in temperatures of a conductor center (1 at an electromagnetic coil, a root 2 of an anti-stress cone, an inner side 3 of the anti-stress cone, an outer side (4 of the anti-stress cone, the middle 5 of the anti-stress cone, and the middle 6 of a conductor shielding restoration over time during preheating. Here, exemplarily, the reference submarine cable factory joint is for a crosslinked polyethylene insulated power cable which is of a voltage class of 110 kV and includes a copper conductor core having a cross-section of 800 mm². As shown in FIG. 6, the temperatures of the key areas (1-6 of the submarine cable factory joint can be maintained stably at 110° C. to 120° C. since the 100th minute. Then, the extrusion procedure for insulation restoration can be carried out at the target submarine cable factory joint. Certainly, considering that the extrusion for insulation restoration is generally performed at a temperature ranging from 110° C. to 120° C. and there is almost no heat transfer process in the chamber of the metal heating mould, the temperatures of the submarine cable factory joint can still be referred to even if the extrusion procedure for insulation restoration is not carried out.

Further, reference is made to FIG. 7. Exemplarily, a reference submarine cable factory joint is for a crosslinked polyethylene insulated power cable which is of a voltage class of 110 kV and includes a copper conductor core having a cross-section of 800 mm². FIG. 7 schematically illustrates a rule of changes in temperatures of the conductor core with cable lengths along a length direction of the cable, such rule is obtained from simulation calculation. That is, FIG. 7 is a schematic diagram of changes in temperatures of the conductor core of the submarine cable factory joint from the center of the submarine cable factory joint along a cable direction. As can be seen from FIG. 7, there is no longer any temperature rise in the cable core at locations away from the center by 4 meters or more. This indicates that in practical applications, a total length of cables on two sides of the reference submarine cable factory joint may be selected based on a standard of 20 meters (the cables on the two sides are equal in length, 10 meters each), and such length is sufficient to ensure that the temperatures of the key areas of the reference submarine cable factory joint remain consistent with the temperatures of the key areas of the target submarine cable factory joint.

Therefore, in practical applications, the temperatures of corresponding key areas in the target submarine cable factory joint can be evaluated by measuring the reference key areas in the reference submarine cable factory joint.

Optionally, the temperatures of the reference key areas in the reference submarine cable factory joint may be obtained by arranging a temperature measurement system in respective key areas of the reference submarine cable factory joint. In an embodiment, the reference submarine cable factory joint includes a temperature measurement system, and the temperature measurement system is arranged in respective reference key areas in the reference submarine cable factory joint.

One temperature measurement system may be arranged in each reference key area in the reference submarine cable factory joint, or one temperature measurement system may be correspondingly arranged in multiple reference key areas or all the reference key areas, which is not limited in the embodiment of the present disclosure.

The temperature measurement system in the embodiment of the present disclosure has a function of measuring the temperatures of the reference key areas. By arranging the temperature measurement system at respective key areas of the reference submarine cable factory joint and collecting the temperatures of respective key areas, the measured temperature values of respective key areas of the reference submarine cable factory joint can be obtained, which is greatly convenient to obtain the measured temperature values of respective key areas of the reference submarine cable factory joint.

In the following, the function and the structure of the above-mentioned temperature measurement system are described according to several embodiments.

In an embodiment, the temperature measurement system includes a temperature sensor, one temperature sensor is arranged in each reference key area, and the measured temperature values of respective reference key areas are collected by the temperature sensors in the respective reference key areas.

It is understandable that, similar to the above description about the temperature measurement system, in the embodiment, one temperature sensor may be arranged in each key reference area, or one temperature sensor may be arranged in a key area which is to be measured currently. In this way, temperature values in corresponding reference key areas can be collected by the temperature sensors.

Optionally, the temperature sensor may be a thermocouple, a thermal resistor, an optical fiber, or the like.

The temperature sensors may be placed at reference key areas of the reference submarine cable factory joint, such as the conductor core at the center of the induction coil, the conductor shielding restoration, and a surface of the anti-stress cone, so that the temperatures of the key areas of the reference submarine cable factory joint can be effectively monitored.

In the embodiment, by arranging one temperature sensor in each key area of the reference submarine cable factory joint, the temperatures of respective key areas can be collected, which effectively ensures temperature monitoring at respective key areas in the reference submarine cable factory joint.

Furthermore, the function of the temperature measurement system is not limited to the above temperature collection, and may further include display of the measured temperature values of respective reference key areas that have been collected. Based on this, in an embodiment, the above-mentioned temperature measurement system further includes a temperature display, and the measured temperature values of respective reference key areas that have been collected are displayed by the temperature display.

In the embodiment, the temperatures of respective key areas of the reference submarine cable factory joint are measured by the temperature sensors, and the measured temperature values that have been collected are displayed by the temperature display.

For example, the temperature display may be a meter display or a digital display. The digital display may be implemented by a liquid crystal display (LCD) or a light-emitting diode (LED), which is not limited in the embodiment of the present disclosure.

In the embodiment, by the temperature display further provided in the temperature measurement system, the temperatures of respective key areas of the reference submarine cable factory joint that have been collected by the temperature sensors can be displayed. Hence, a user can quickly and conveniently grasp the temperatures of respective key areas of the target submarine cable factory joint.

Heating devices for the reference submarine cable factory joint and the target submarine cable factory joint are the same, and both the metal heating moulds and the magnetic induction heating systems included in the heating devices are the same. Therefore, by monitoring the temperatures of the reference submarine cable factory joint, the temperatures of the key areas in the target submarine cable factory joint can be adjusted and controlled. In this way, even if an emergency occurs, such as power outage or ambient temperature changes, an operator can still effectively determine changes in the temperatures of the key areas of the target submarine cable factory joint, facilitating adjustment to subsequent processes. Therefore, monitoring of the temperatures of the target submarine cable factory joint can be realized indirectly due to consistency between the temperatures of the reference submarine cable factory joint and the temperatures of the target submarine cable factory joint. Consistency between the temperatures of the key areas of the two joints can be ensured as long as the main body structure of the reference submarine cable factory joint is the same as that of the target submarine cable factory joint.

The measured temperature values of respective reference key areas of the reference submarine cable factory joint are indirectly equivalent to real-time temperatures of respective key areas of the target submarine cable factory joint. The temperatures of respective key areas of the target submarine cable factory joint reflect temperatures of the target submarine cable factory joint during a heating link in the manufacturing. Once it is found that the temperatures of respective key areas of the target submarine cable factory joint do not meet temperature requirements for the heating link in the manufacturing, the temperatures of respective key areas can be adjusted and controlled to ensure standardization of the manufacturing process and subsequent processes of the target submarine cable factory joint.

Based on the above, in an embodiment, the above-mentioned temperature measurement system may further include a temperature controller. The temperature controller sends a temperature adjustment instruction to the induction heating system in case that the measured temperature values of respective reference key areas are not within preset target temperature ranges for respective key areas. The temperature adjustment instruction is utilized to instruct the induction heating system to adjust temperatures of respective measurement key areas to be within the corresponding target temperature ranges.

The temperature measurement system arranged in respective key areas of the reference submarine cable factory joint can realize temperature monitoring and display. With the temperature controller included therein, the temperature measurement system can be linked with the induction heating power supply to realize a temperature control function. The temperatures of respective key areas of the reference submarine cable factory joint measured by the temperature measurement system are compared with the preset target temperature ranges for respective key areas. The temperature measurement system sends a temperature adjustment instruction to the induction heating system in case that the measured temperature values of respective reference key areas are not within the preset target temperature ranges for respective key areas. Then, the induction heating system may adjust temperatures of respective measurement key areas to be within the corresponding target temperature ranges.

It is understandable that, in the embodiment of the present disclosure, the reference submarine cable factory joint and the target submarine cable factory joint utilize same induction heating systems. In case of finding that the measured temperature value of a certain reference key area is not within the preset target temperature range for the key area, the temperature of a corresponding key area of the target submarine cable factory joint can be adjusted to be within a corresponding target temperature range by instructing the induction heating system.

For example, among reference key areas 1 to 5 of the reference submarine cable factory joint, the measured temperature values of key areas 1 and 3 are not within corresponding preset target temperature ranges, which indicates that the temperatures of key areas 1 and 3 of the target submarine cable factory joint are also not within the target temperature ranges. Then, the temperature controller sends a temperature adjustment instruction to the induction heating system, and the induction heating system may adjust the temperatures of the key areas 1 and 3 of the target submarine cable factory joint to be within the corresponding target temperature ranges.

In the embodiment, by providing the temperature controller inside the temperature measurement system and linking the temperature measurement system with the induction heating power supply, temperatures beyond the preset target temperature ranges of respective key areas can be adjusted and controlled, to enable measured temperatures of respective key areas to be within the preset target temperature ranges. Thus, heating condition can be reasonably adjusted and controlled when manufacturing the submarine cable factory joint.

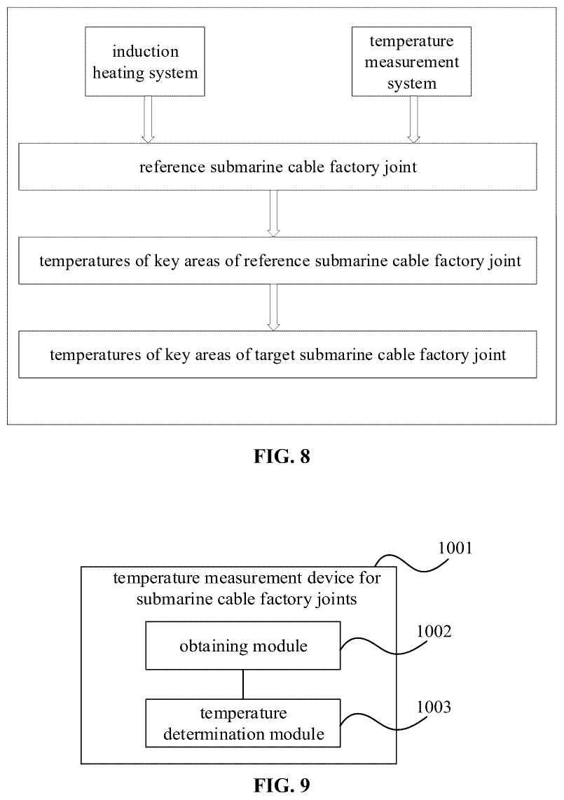

In addition, the present disclosure further provides an embodiment of obtaining temperatures of key areas of a target submarine cable factory joint based on the reference submarine cable factory joint. FIG. 8 is a schematic flowchart of obtaining the temperatures of the key areas of the target submarine cable factory joint based on the reference submarine cable factory joint.

With reference to FIG. 4, it is understandable that the target submarine cable factory joint in FIG. 8 may be a submarine cable factory joint that includes a conductor core, an insulating material extrusion flow channel port, a silicone rubber gasket, an anti-stress cone, a metal heating mould, and a metal cooling jacket, has completed steps such as shaping and grinding of the anti-stress cone, welding (or pressure welding) of the conductor core, conductor shielding wrapping, and the like and is about to undergo steps such as preheating of the anti-stress cone and extrusion for insulation restoration, and may alternatively refer to a submarine cable factory joint that has completed steps such as molding of extrusion for insulation restoration and is about to undergo a step of heat-induced crosslink for insulation restoration. The main body structure of the reference submarine cable factory joint is the same as that of the target submarine cable factory joint. In addition, the reference submarine cable factory joint and the target submarine cable factory joint utilize same induction heating systems, where the length of the induction heating system is equal to or longer than 20 meters. The two submarine cable factory joints are placed side by side with a spacing of 0.5 meters to 1 meter to ensure that the two submarine cable factory joints are in the same environment and are not affected by magnetic fields generated by electromagnetic coils of each other. The induction heating system for each of the two submarine cable factory joints includes an electromagnetic coil and an induction heating power supply. The electromagnetic coil is arranged on two sides of the metal cooling jacket, and a distance between the electromagnetic coil and the metal cooling jacket is equal to or longer than 5 cm. A frequency of an output current of the induction heating power supply ranges from 1 kHz to 50 kHz. The frequency in the range can quickly heat up the conductor core at the induction coil and ensure that the insulation shielding at the induction coil may not be heated up excessively under the action of the magnetic field. An electric power is controlled equal to or more than 10 kW, which can enable rapid heating of the conductor core. A temperature measurement system includes a temperature sensor, a temperature display, and a temperature controller.

In this way, when a high-frequency large current is applied to the electromagnetic coil, the magnetic field generated can pass through the insulation shielding and the insulation layer, causing the conductor core at a position corresponding to the electromagnetic coil to generate an eddy current and rapidly heat up, and then heat is transferred to the conductor core at the submarine cable factory joint to heat up the conductor shielding restoration and an inner side of the anti-stress cone. Temperature sensors are placed in key areas of the reference submarine cable factory joint, including the conductor core at the center of the induction coil, the conductor shielding restoration, and a surface of the anti-stress cone to collect the temperatures of respective reference key areas. The collected temperatures may be displayed by the temperature display. The temperature controller is linked to the induction heating power supply. The temperatures of respective key areas of the reference submarine cable factory joint that have been measured are compared with preset target temperature ranges for respective key areas. A temperature adjustment instruction is sent to the induction heating system in case that the measured temperature values of the reference key areas are not within the preset target temperature ranges for the reference areas, and the temperature controller may adjust temperatures of respective measurement key areas to be within corresponding target temperature ranges. In this way, the collected temperatures of respective key areas of the reference submarine cable factory joint are determined to be the temperatures of the target submarine cable factory joint.

In the embodiment, the main body structure of the reference submarine cable factory joint is the same as that of the target submarine cable factory joint, the metal heating moulds utilized by the reference submarine cable factory joint and the target submarine cable factory joint are the same, and the reference submarine cable factory joint and the target submarine cable factory joint utilize same induction heating systems. In this way, in case that the cable length of the reference submarine cable factory joint is equal to or longer than 20 meters, the temperatures of key areas of the reference submarine cable factory joint are the same as the temperatures of key areas of the target submarine cable factory joint. The temperature sensors may be placed in the key areas of the reference submarine cable factory joint. The temperatures of the target submarine cable factory joint can be detected by measuring temperatures using the temperature sensors, and the heating condition can be properly adjusted and controlled. Due to consistent temperature distributions in the reference submarine cable factory joint and the target submarine cable factory joint, the temperatures of the key areas of the target submarine cable factory joint can be monitored on the basis of ensuring integrity and purity of the target submarine cable factory joint, and finally accurate monitoring of the temperatures of the key areas of the target submarine cable factory joint during the heating can be achieved.

It should be understood that, although the steps in the flowcharts involved in the above embodiments are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the above embodiments may include multiple sub-steps or multiple stages, and such sub-steps or stages are not necessarily performed at a same moment, they may be performed at different moments. The sub-steps or stages are not necessarily performed in sequence, and the sub-steps or stages may be performed in turn or alternately with at least some of other steps or sub-steps or stages of other steps.

Based on similar inventive concept, a temperature measurement device for submarine cable factory joints is further provided according to an embodiment of the present disclosure, which can implement the foregoing temperature measurement method for submarine cable factory joints. Solution for solving problems provided by the temperature measurement device is similar to above-described solution provided by the foregoing temperature measurement method. Therefore, limitations to the foregoing temperature measurement method for submarine cable factory joints may be referred to in understanding limitations to the temperature measurement device for submarine cable factory joints provided in hereinafter one or more embodiments, which are not repeated herein.

In an embodiment, a temperature measurement device 1001 for submarine cable factory joints is provided. As shown in FIG. 9, the temperature measurement device 1001 includes an obtaining module 1002 and a temperature determination module 1003.

The obtaining module 1002 is configured to obtain measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side.

The temperature determination module 1003 is configured to determine the measured temperature values of the respective reference key areas as measured temperature values of corresponding measurement key areas of the target submarine cable factory joint.

In an embodiment, the reference submarine cable factory joint includes a temperature measurement system. The temperature measurement system is arranged in respective reference key areas in the reference submarine cable factory joint. The obtaining module 1002 is further configured to collect temperatures of respective reference key areas through the temperature measurement system in respective reference key areas, to obtain the measured temperature values of respective reference key areas of the reference submarine cable factory joint.

In an embodiment, the temperature measurement system includes a temperature sensor. One temperature sensor is arranged in each reference key area. The measured temperature values of respective reference key areas are collected by the temperature sensors in the respective reference key areas.

In an embodiment, the temperature measurement system further includes a temperature display, and the temperature measurement device includes:
a temperature collection module, configured to display, through the temperature display, the measured temperature values of respective reference key areas that have been collected.

In an embodiment, the temperature measurement system further includes a temperature controller, the reference submarine cable factory joint and the target submarine cable factory joint utilize same induction heating systems, and the temperature measurement device further includes:
a temperature adjustment module, configured to send a temperature adjustment instruction to the induction heating system in case that the measured temperature values of respective reference key areas are not within preset target temperature ranges for respective key areas, the temperature adjustment instruction being configured to instruct the induction heating system to adjust temperatures of respective measurement key areas to be within corresponding target temperature ranges.

In an embodiment, the reference submarine cable factory joint and the target submarine cable factory joint include same metal cooling jackets and same metal heating moulds. The metal heating mould is arranged at an anti-stress cone of the target submarine cable factory joint or the reference submarine cable factory joint. The metal cooling jacket is located on two sides of the metal heating mould and in close contact with the metal heating mould and an outer side of a cable.

In an embodiment, the induction heating system includes an electromagnetic coil and an induction heating power supply. The electromagnetic coil is arranged on two sides of the metal cooling jacket. A distance between the electromagnetic coil and the metal cooling jacket is greater than a preset distance.

The modules in the temperature measurement device for submarine cable factory joints may be implemented entirely or partially by software, hardware, or a combination thereof. The above modules may be built in or independent from a processor of a computer apparatus in a hardware form, or may be stored in a memory of the computer apparatus in a software form, to facilitate the processor to invoke the above modules and perform operations corresponding to the above modules.

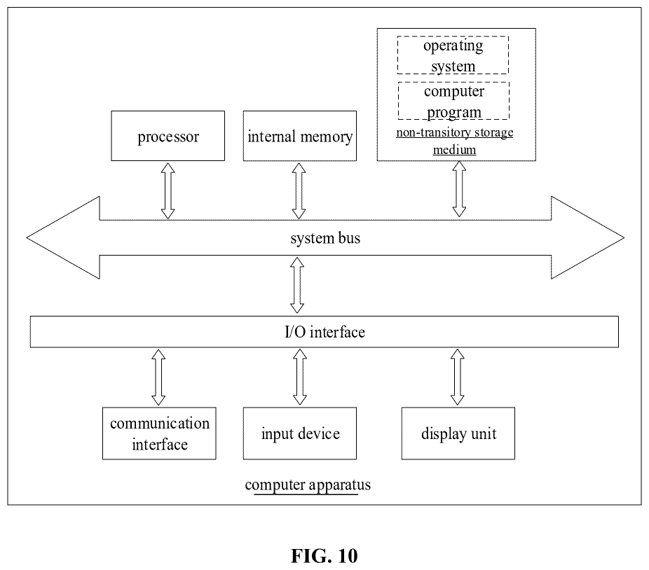

In an embodiment, a computer apparatus is provided. The computer apparatus may be a terminal. An internal structure of the computer apparatus may be shown in FIG. 10. The computer apparatus includes a processor, a memory, a communication interface, a display unit, and an input device. The processor of the computer apparatus is configured to provide computing and control capabilities. The memory of the computer apparatus includes a non-transitory storage medium and an internal memory. The non-transitory storage medium stores an operating system and a computer program. The internal memory provides an environment for running of the operating system and the computer program in the non-transitory storage medium. The communication interface of the computer apparatus is configured to communicate with an external terminal in a wired or wireless manner. The wireless manner may be implemented by WIFI, mobile cellular networks, near field communication (NFC), or other technologies. The computer program is executed by the processor to implement a temperature measurement method for submarine cable factory joints. The display unit of the computer apparatus may be a liquid crystal display screen or an electronic ink display screen. The input device of the computer apparatus may be a touch layer covering the display unit, or may be a key, a trackball, or a touchpad disposed on a housing of the computer apparatus, or may be an external keyboard, a touchpad, a mouse, or the like.

Those skilled in the art may understand that, the structure shown in FIG. 10 is only a block diagram of a partial structure related to a solution of the present disclosure, which does not constitute a limitation on the computer apparatus to which the solution of the present disclosure is applied. Specifically, the computer apparatus may include more or fewer components than those shown in FIG. 10, or some components may be combined, or a different component deployment may be used.

In an embodiment, a computer apparatus is further provided, including a memory and a processor. The memory stores a computer program. The processor, when executing the computer program, implements the following steps:
obtaining measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side; and
determining the measured temperature values of respective reference key areas as measured temperature values of corresponding measurement key areas of the target submarine cable factory joint.

In an embodiment, the reference submarine cable factory joint includes a temperature measurement system. The temperature measurement system is arranged in respective reference key areas in the reference submarine cable factory joint. The processor, when executing the computer program, further implements the following step:
collecting temperatures of respective reference key areas through the temperature measurement system in respective reference key areas, to obtain the measured temperature values of respective reference key areas of the reference submarine cable factory joint.

In an embodiment, the temperature measurement system includes a temperature sensor. One temperature sensor is arranged in each reference key area. The measured temperature values of respective reference key areas are collected by the temperature sensors in the respective reference key areas.

In an embodiment, the temperature measurement system further includes a temperature display, and the processor, when executing the computer program, further implements the following step:
displaying, through the temperature display, the measured temperature values of respective reference key areas that have been collected.

In an embodiment, the temperature measurement system further includes a temperature controller, the reference submarine cable factory joint and the target submarine cable factory joint utilize same induction heating systems, and the processor, when executing the computer program, further implements the following step:
sending a temperature adjustment instruction to the induction heating system in case that the measured temperature values of respective reference key areas are not within preset target temperature ranges for respective key areas, the temperature adjustment instruction being configured to instruct the induction heating system to adjust temperatures of respective measurement key areas to be within corresponding target temperature ranges.

In an embodiment, the reference submarine cable factory joint and the target submarine cable factory joint include same metal cooling jackets and same metal heating moulds. The metal heating mould is arranged on an outer side of an anti-stress cone of the target submarine cable factory joint or the reference submarine cable factory joint. The metal cooling jacket is located on two sides of the metal heating mould and in close contact with the metal heating mould and an outer side of a cable.

In an embodiment, the induction heating system includes an electromagnetic coil and an induction heating power supply. The electromagnetic coil is arranged on two sides of the metal cooling jacket. A distance between the electromagnetic coil and the metal cooling jacket is greater than a preset distance.

The principle and processes in implementing the computer apparatus provided above according to respective embodiments may be understood with reference to the description about the temperature measurement method for submarine cable factory joints in the foregoing embodiments, which are not repeated herein.

In an embodiment, a computer-readable storage medium is provided, having a computer program stored thereon. When the computer program is executed by a processor, the following steps are implemented:
obtaining measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side; and
determining the measured temperature values of respective reference key areas as measured temperature values of corresponding measurement key areas of the target submarine cable factory joint.

In an embodiment, the reference submarine cable factory joint includes a temperature measurement system. The temperature measurement system is arranged in respective reference key areas in the reference submarine cable factory joint. When the computer program is executed by the processor, the following step is implemented:
collecting temperatures of respective reference key areas through the temperature measurement system in respective reference key areas, to obtain the measured temperature values of respective reference key areas of the reference submarine cable factory joint.

In an embodiment, the temperature measurement system includes a temperature sensor. One temperature sensor is arranged in each reference key area. The measured temperature values of respective reference key areas are collected by the temperature sensors in respective reference key areas.

In an embodiment, the temperature measurement system further includes a temperature display, and when the computer program is executed by the processor, the following step is implemented:
displaying, through the temperature display, the measured temperature values of respective reference key areas that have been collected.

In an embodiment, the temperature measurement system further includes a temperature controller, the reference submarine cable factory joint and the target submarine cable factory joint utilize same induction heating systems, and when the computer program is executed by the processor, the following step is implemented:
sending a temperature adjustment instruction to the induction heating system in case that the measured temperature values of respective reference key areas are not within preset target temperature ranges for respective key areas, the temperature adjustment instruction being configured to instruct the induction heating system to adjust temperatures of respective measurement key areas to be within corresponding target temperature ranges.

In an embodiment, the reference submarine cable factory joint and the target submarine cable factory joint include same metal cooling jackets and same metal heating moulds. The metal heating mould is arranged on an outer side of an anti-stress cone of the target submarine cable factory joint or the reference submarine cable factory joint. The metal cooling jacket is located on two sides of the metal heating mould and in close contact with the metal heating mould and an outer side of a cable.

In an embodiment, the induction heating system includes an electromagnetic coil and an induction heating power supply. The electromagnetic coil is arranged on two sides of the metal cooling jacket. A distance between the electromagnetic coil and the metal cooling jacket is greater than a preset distance.

The principle and processes in implementing the computer-readable storage medium provided above according to respective embodiments may be understood with reference to the description about the temperature measurement method for submarine cable factory joints in the foregoing embodiments, which are not repeated herein.

In an embodiment, a computer program product is provided, including a computer program. When the computer program is executed by a processor, the following steps are implemented:
obtaining measured temperature values of respective reference key areas of a reference submarine cable factory joint, where a main body structure of the reference submarine cable factory joint is the same as that of a target submarine cable factory joint, the environment where the reference submarine cable factory joint is located is the same as the environment where the target submarine cable factory joint is located, and the reference submarine cable factory joint and the target submarine cable factory joint are spaced apart from each other by a preset distance and then placed side by side; and
determining the measured temperature values of respective reference key areas as measured temperature values of corresponding measurement key areas of the target submarine cable factory joint.

In an embodiment, the reference submarine cable factory joint includes a temperature measurement system. The temperature measurement system is arranged in respective reference key areas in the reference submarine cable factory joint. When the computer program is executed by the processor, the following step is further implemented:
collecting temperatures of respective reference key areas through the temperature measurement system in respective reference key areas, to obtain the measured temperature values of respective reference key areas of the reference submarine cable factory joint.

In an embodiment, the temperature measurement system includes a temperature sensor. One temperature sensor is arranged in each reference key area. The measured temperature values of respective reference key areas are collected by the temperature sensors in respective reference key areas.

In an embodiment, the temperature measurement system further includes a temperature display, and when the computer program is executed by the processor, the following step is further implemented:
displaying, through the temperature display, the measured temperature values of respective reference key areas that have been collected.

In an embodiment, the temperature measurement system further includes a temperature controller, the reference submarine cable factory joint and the target submarine cable factory joint utilize same induction heating systems, and when the computer program is executed by the processor, the following step is further implemented:
sending a temperature adjustment instruction to the induction heating system in case that the measured temperature values of respective reference key areas are not within preset target temperature ranges for respective key areas, the temperature adjustment instruction being configured to instruct the induction heating system to adjust temperatures of respective measurement key areas to be within the corresponding target temperature ranges.

In an embodiment, the reference submarine cable factory joint and the target submarine cable factory joint include same metal cooling jackets and same metal heating moulds. The metal heating mould is arranged on an outer side of an anti-stress cone of the target submarine cable factory joint or the reference submarine cable factory joint. The metal cooling jacket is located on two sides of the metal heating mould and in close contact with the metal heating mould and an outer side of a cable.

In an embodiment, the induction heating system includes an electromagnetic coil and an induction heating power supply. The electromagnetic coil is arranged on two sides of the metal cooling jacket. A distance between the electromagnetic coil and the metal cooling jacket is greater than a preset distance.

The principle and processes in implementing the computer program product provided above according to respective embodiments may be understood with reference to the description about the temperature measurement method for submarine cable factory joints in the foregoing embodiments, which are not repeated herein.

Those of ordinary skill in the art may understand that some or all procedures in the methods in the foregoing embodiments may be implemented by a computer program instructing related hardware, the computer program may be stored in a non-transitory computer-readable storage medium, and when the computer program is executed, the procedures in the foregoing method embodiments may be implemented. Any reference to the memory, database, or other media used in the embodiments provided in the present disclosure may include at least one of a non-transitory memory and a volatile memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. By way of illustration instead of limitation, the RAM is available in a variety of forms, such as a static random access memory (SRAM) or a dynamic random access memory (DRAM). The database as referred to in the embodiments provided in the present disclosure may include at least one of a relational database and a non-relational database. The non-relational database may include a blockchain-based distributed database, and the like, but is not limited thereto. The processor as referred to in the embodiments provided in the present disclosure may be a general-purpose processor, a central processing unit, a graphics processor, a digital signal processor, a programmable logic device, a data processing logic device based on quantum computing, and the like, but is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A temperature measurement method for submarine cable factory joints, comprising:
obtaining measured temperature values of respective reference key areas of a reference submarine cable factory joint, wherein a main body structure of the reference submarine cable factory joint is the same as that of a target submarine cable factory joint, environment where the reference submarine cable factory joint is located is the same as environment where the target submarine cable factory joint is located, and the reference submarine cable factory joint and the target submarine cable factory joint are spaced apart from each other by a preset distance and then placed side by side; and
determining the measured temperature values of the respective reference key areas as measured temperature values of corresponding measurement key areas of the target submarine cable factory joint.

2. The temperature measurement method according to claim 1, wherein the reference submarine cable factory joint comprises a temperature measurement system, the temperature measurement system being arranged in the respective reference key areas of the reference submarine cable factory joint; and
obtaining the measured temperature values of the respective reference key areas of the reference submarine cable factory joint comprises:
collecting temperatures of the respective reference key areas through the temperature measurement system in the respective reference key areas, to obtain the measured temperature values of the respective reference key areas of the reference submarine cable factory joint.

3. The temperature measurement method according to claim 2, wherein the temperature measurement system comprises a temperature sensor; wherein one temperature sensor is arranged in each reference key area, and the measured temperature values of the respective reference key areas are collected by the temperature sensors in the respective reference key areas.

4. The temperature measurement method according to claim 2 or 3, wherein the temperature measurement system further comprises a temperature display; and the temperature measurement method further comprises:
displaying, through the temperature display, the measured temperature values of the respective reference key areas that have been collected.

5. The temperature measurement method according to claim 2 or 3, wherein the temperature measurement system further comprises a temperature controller; the reference submarine cable factory joint and the target submarine cable factory joint utilize same induction heating systems; and the temperature measurement method further comprises:
sending a temperature adjustment instruction to the induction heating system if the measured temperature values of the respective reference key areas are not within preset target temperature ranges for respective key areas, the temperature adjustment instruction being configured to instruct the induction heating system to adjust temperatures of the respective measurement key areas to be within corresponding target temperature ranges.

6. The temperature measurement method according to claim 5, wherein the reference submarine cable factory joint and the target submarine cable factory joint comprise same metal cooling jackets and same metal heating moulds;
wherein the metal heating mould is arranged on an outer side of an anti-stress cone of the target submarine cable factory joint or the reference submarine cable factory joint, and the metal cooling jacket is located on two sides of the metal heating mould and in close contact with the metal heating mould and an outer side of a cable.

7. The temperature measurement method according to claim 6, wherein the induction heating system comprises an electromagnetic coil and an induction heating power supply;
wherein the electromagnetic coil is arranged on two sides of the metal cooling jacket, and a distance between the electromagnetic coil and the metal cooling jacket is greater than a preset distance.

8. A temperature measurement device for submarine cable factory joints, comprising:
an obtaining module, configured to obtain measured temperature values of respective reference key areas of a reference submarine cable factory joint, wherein a main body structure of the reference submarine cable factory joint is the same as that of a target submarine cable factory joint, environment where the reference submarine cable factory joint is located is the same as environment where the target submarine cable factory joint is located, and the reference submarine cable factory joint and the target submarine cable factory joint are spaced apart from each other by a preset distance and then placed side by side; and
a temperature determination module, configured to determine the measured temperature values of the respective reference key areas as measured temperature values of corresponding measurement key areas of the target submarine cable factory joint.

9. A computer apparatus, comprising a memory and a processor, wherein the memory stores a computer program, and the processor, when executing the computer program, implementing steps of the temperature measurement method according to any one of claims 1 to 7.

10. A computer-readable storage medium, having a computer program stored thereon, wherein the computer program, when executed by a processor, implements steps of the temperature measurement method according to any one of claims 1 to 7.
